(19) United States
(12) Patent Application Publication
(10) Pub. No.: US 2026/0262866 A1
(43) Pub. Date: Sep. 10, 2026

(54) STEAMED RICE PRODUCTION METHOD AND STEAMED RICE PRODUCTION APPARATUS

(71) Applicant: NICHIREI FOODS INC., Tokyo-to (JP)

(72) Inventors: Tsukasa SHIDA, Tokyo-to (JP); Masao SAWADA, Tokyo-to (JP); Daisuke SHIMIZU, Tokyo-to (JP); Hiroaki MURATA, Tokyo-to (JP)

(73) Assignee: NICHIREI FOODS INC., Tokyo-to (JP)

(21) Appl. No.: 18/847,052

(22) PCT Filed: Mar. 15, 2023
(86) PCT No.: PCT/JP2023/010204

§ 371 Date: Sep. 13, 2024

(30) Foreign Application Priority Data
Mar. 16, 2022 (JP) 2022-041634

(51) Int. Cl. A47J 27/04; A23L 5/10; A23L 7/196

(52) U.S. Cl. CPC A47J 27/04; A23L 5/13; A23L 7/196; A47J 2027/043

(57) ABSTRACT

A steamed rice production method includes: a first rice steaming step of, in a first zone in a steamed rice production apparatus, supplying a replenishment liquid containing water a rice foodstuff containing rice and steaming the rice foodstuff by steam; and a second rice steaming step of, in a second zone in the steamed rice production apparatus, steaming the rice foodstuff by steam after the first rice steaming step without supplying water to the rice foodstuff.

### TECHNICAL FIELD

The present disclosure relates to a steamed rice production method and a steamed rice production apparatus.

### BACKGROUND ART

Unlike rice cooking methods using a kettle, a steaming rice method of performing rice cooking by steaming rice with high-temperature water vapor in a state where the rice is not basically immersed in water is known.

For example, Patent Literature 1 discloses a steamed rice production method that aims to perform rice cooking without immersing the rice in water.

### CITATION LIST

### Patent Literature

[Patent Literature 1] Japanese Patent Application Publication No. 2014-226062

### SUMMARY OF INVENTION

The quality of rice cooking is evaluated from multiple perspectives including whether or not it is possible to provide cooked rice with a taste and texture suited to consumer preferences, whether or not variations in the quality of cooked rice are sufficiently suppressed, and the amount of rice cooked per unit time (i.e., productivity).

The above-mentioned steaming rice method using steam is suitable for continuously and stably cooking large amounts of rice. However, general steaming rice methods do not always provide a stable supply of high-quality cooked rice.

The present disclosure provides a technique associated with steaming rice that is advantageous for providing cooked rice of excellent quality.

One aspect of the present disclosure is directed to a steamed rice production method including: a first rice steaming step of, in a first zone in a steamed rice production apparatus, supplying a replenishment liquid containing water to a rice foodstuff containing rice and steaming the rice foodstuff by steam; and a second rice steaming step of, in a second zone in the steamed rice production apparatus, steaming the rice foodstuff by steam after the first rice steaming step without supplying water to the rice foodstuff.

Another aspect of the present disclosure is directed to a steamed rice production apparatus comprising: a conveyance unit that conveys a rice foodstuff containing rice throughout a rice steaming zone that includes a first zone and a second zone located downstream from the first zone; a steam supply unit that supplies steam to the first zone and the second zone; and a water supply unit that supplies a replenishment liquid containing water to the rice foodstuff conveyed by the conveyance unit in the first zone, wherein in the second zone, the rice foodstuff conveyed by the conveyance unit is steamed by the steam but does not receive supply of water.

According to the present disclosure, it is advantageous for providing cooked rice of excellent quality.

### BRIEF DESCRIPTION OF DRAWINGS

FIG. 1 shows an example of a steamed rice production apparatus according to a first embodiment.

### DESCRIPTION OF EMBODIMENTS

In general, to produce frozen processed rice food items, a rice cooking step, a step of mixing seasonings and ingredients with the cooked rice, other processing steps, a freezing step, and a packaging step may be performed sequentially.

The rice cooking step here can be executed in various ways, and for instance, it is possible to perform rice cooking using a kettle or to perform rice cooking by steaming rice with water vapor. In particular, a steamed rice cooking method in which rice cooking is performed by steaming rice with water vapor while conveying the rice, is advantageous from the perspective of being capable of continuously producing a large amount of cooked rice (steamed rice) and continuously executing various processes downstream from the rice cooking process without delay.

The following describes embodiments of a steamed rice production method and a steamed rice production apparatus that steam rice with vapor to produce cooked rice.

The apparatus and the method of each of the following embodiments can be suitably applied to production methods and production apparatuses for frozen processed rice food products (in particular, to rice cooking methods and rice cooking apparatuses), but can also be applied to simple rice cooking methods and rice cooking apparatuses and to methods and apparatuses used for any other use applications.

In the following description, unless otherwise specified, the terms “upstream” and “downstream” are based on the conveyance of rice (a rice foodstuff), and terms related to the vertical direction, such as “up” and “down”, are based on the height direction (i.e., the direction along the direction of gravitational force).

### First Embodiment

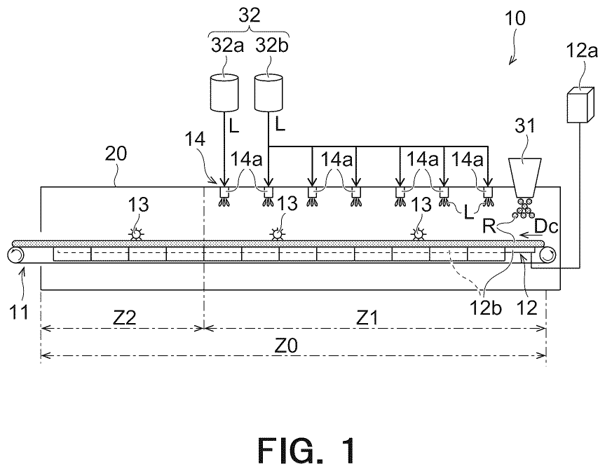

FIG. 1 shows an example of a steamed rice production apparatus 10 according to a first embodiment. In FIG. 1, the state of the inside of a chamber unit 20 is shown.

In the steamed rice production apparatus 10 shown in FIG. 1, a rice steaming zone Z0 inside the chamber unit 20 where rice cooking is performed by steaming rice, is divided into a first zone Z1 and a second zone Z2.

The first zone Z1 is a section where a first rice steaming step in which rice is steamed by steam while water is added is performed. On the other hand, the second zone Z2 is a section where a second rice steaming step in which rice is steamed by steam while water is not added is performed. Therefore, the steamed rice production method of the present embodiment includes: the first rice steaming step in which the rice is steamed by steam while water (a replenishment liquid L described below) is supplied to the rice in the first zone Z1; and the second rice steaming step in which the rice is steamed by steam in the second zone Z2 after the first rice steaming step, without water being supplied to the rice.

In the present embodiment, the first zone Z1 and the second zone Z2 are positioned to be horizontally staggered. Rice to be cooked (specifically, a rice foodstuff R) is conveyed from the first zone Z1 to second zone Z2, without interruption, by a common conveyance unit 11.

The steamed rice production apparatus 10 shown in FIG. 1 comprises a rice supply unit 31, the conveyance unit 11, a steam supply unit 12, stirring devices 13 and a water supply unit 14.

The rice supply unit 31 is provided at least partially outside the chamber unit 20. On the other hand, each of the conveyance unit 11, the steam supply unit 12, the stirring devices 13 and the water supply unit 14 is provided at least partially inside the chamber unit 20.

Inside the chamber unit 20 (i.e., the first zone Z1 and the second zone Z2), the ambient temperature around a rice foodstuff R conveyed by the conveyance unit 11 is at a temperature suitable for steaming rice, for example, 90° C. or higher (more preferably 95° C. or higher).

The atmosphere inside the chamber unit 20 has a temperature that is basically higher than room temperature due to the steam from the steam supply unit 12 and a replenishment liquid L from the water supply unit 14. Therefore, it is also possible to adjust the ambient temperature in the chamber unit 20 to a desired temperature suitable for steamed rice cooking by only the steam from the steam supply unit 12 and the replenishment liquid L from the water supply unit 14.

However, a heater (not shown in the drawing) to adjust the atmosphere around a rice foodstuff R conveyed by the conveyance unit 11 to a desired temperature suitable for rice steaming may be installed in the chamber unit 20.

The rice supply unit 31 is attached to the chamber unit 20 and includes a hopper that stores a rice foodstuff R outside the chamber unit 20, and supplies the rice foodstuff R to the conveyance unit 11 inside the chamber unit 20. The specific configuration of the rice supply unit 31 is not limited, but the rice supply unit 31 supplies a desired amount of rice foodstuff R based on needs to the conveyance unit 11 in a timely manner under the control of a control unit (not shown in the drawing).

The rice contained in a rice foodstuff R supplied from the rice supply unit 31 to the conveyance unit 11 is rice before cooking.

A rice foodstuff R typically contains only rice, but may include other ingredients in addition to rice. Ingredients other than rice that may be included in a rice foodstuff R are not limited. For example, any ingredient and any seasoning to be mixed with rice may be included in the rice foodstuff R as other ingredients.

The rice included in a rice foodstuff R supplied from the rice supply unit 31 to the conveyance unit 11 may be rice that has absorbed water by being pre-soaked in water. As an example, a rice foodstuff R containing rice that has been pre-soaked in water for 1 hour or more and 30 hours or less in an environment having room temperature (1 to 30° C. (e.g., 25° C.)) or temperature lower than the room temperature, may be stored in the rice supply unit 31. However, the rice supply unit 31 may store rice that has not been pre-soaked in water and supply it to the conveyance unit 11.

The conveyance unit 11 conveys a rice foodstuff R throughout the entire rice steaming zone Z0 including the first zone Z1 and the second zone Z2, which is located downstream from the first zone Z1.

The conveyance unit 11 shown in FIG. 1 has an endless conveyance belt supported by two or more rotary rollers. The downstream-most rotary roller is provided outside the chamber unit 20, and the conveyance belt extends inside and outside the chamber unit 20. At least one of the two or more rotary rollers is rotated by power from a power source (not shown in the drawing), such as a motor, in such a manner that the conveyance unit 11 is caused to move continuously or intermittently.

A rice foodstuff R supplied from the rice supply unit 31 is put on a part of the conveyance belt that has an exposed surface facing upward (hereinafter also referred to as an “upper belt part”), and the part of the conveyance belt that has an exposed surface facing upward moves through the first zone Z1 and the second zone Z2 with the rice foodstuff R being put thereon.

A rice foodstuff R on the conveyance belt is steamed and cooked by steam while passing through the first zone Z1 and the second zone Z2, and is conveyed outside the chamber unit 20 in the form of cooked rice. The cooked rice foodstuff R is sent outside the chamber unit 20 to another device provided downstream (e.g., a rice processing device or a cooked rice storage unit).

A lot of belt through holes are formed in the conveyance belt throughout (not shown in the drawing), and for instance, the conveyance belt may be configured by a net conveyor. The diameter of each belt through hole is not limited, but each belt through hole has a diameter (typically a few millimeters or less (e.g., 1 to 2 mm or less)) large enough to allow steam from the steam supply unit 12 and a replenishment liquid L from the water supply unit 14 to pass therethrough.

The steam supply unit 12 supplies steam to the first zone Z1 and the second zone Z2. A rice foodstuff R conveyed by the conveyance unit 11 is cooked by being steamed by steam supplied from the steam supply unit 12.

The steam supplied from the steam supply unit 12 is typically water vapor, but may also be steam containing components other than water. Further, steam supplied from the steam supply unit 12 is not limited to saturated steam, but may also include superheated steam.

The steam supply unit 12 shown in FIG. 1 comprises: a steam generation unit 12a that generates steam outside the chamber unit 20; and a steam jet line 12b that spurts out steam, sent from the steam generation unit 12a, inside the chamber unit 20.

The steam jet line 12b is located below the upper belt part of the conveyance belt of conveyance unit 11 and has a lot of steam jet holes (not shown in the drawing) that blow out steam.

The steam jet line 12b extends over the first zone Z1 and the second zone Z2 between a part of the conveyance belt whose exposed surface faces downward (hereinafter also referred to as a “lower belt part”) and the upper belt part.

A lot of steam jet holes that the steam jet line 12b has are scattered evenly in the first zone Z1 and the second zone 72. Steam blown out from each steam jet hole of the steam jet line 12b passes through the belt through-holes of the conveyance belt of the conveyance unit 11 and moves above the conveyance belt. As a result, the steam surrounds a rice foodstuff R on the conveyance belt (the upper belt part) and is used to steam the rice foodstuff R.

In at least one of the first zone Z1 and the second zone Z2, at least one stirring device 13 that stirs a rice foodstuff R conveyed by the conveyance unit 11 is provided.

In the example shown in FIG. 1, a plurality of stirring devices 13 are provided above the conveyance belt (in particular, the upper belt part) of the conveyance unit 11 over the first zone Z1 and the second zone Z2. Each stirring device 13 has a body portion that is provided to be able to rotate and a plurality of blade portions extending outwardly from the periphery of the body portion. As the body portion rotates, each blade portion contacts a rice foodstuff R on the conveyance belt while being rotating, thereby promoting agitation of the rice foodstuff R.

The stirring devices 13 are not limited to the example shown in FIG. 1, and may have any configuration. For example, the stirring devices 13 may blow air onto a rice foodstuff R or vibrate a rice foodstuff R through the conveyance belt, instead of the manner of directly contacting and stirring a rice foodstuff R on the conveyance belt.

The water supply unit 14 supplies a replenishment liquid L containing water to a rice foodstuff R conveyed by the conveyance unit 11 in the first zone Z1 by water sprinkling. In other words, the water supply unit 14 has a plurality of liquid discharge outlets (not shown in the drawing) and discharges a replenishment liquid L in a shower-like manner from these liquid discharge outlets to a rice foodstuff R on the conveyance belt. As a result, a replenishment liquid L from the water supply unit 14 is uniformly supplied to the entire rice foodstuff R moving in the first zone Z1 along with the conveyance belt. The discharging of the replenishment liquid L from the plurality of liquid discharge outlets may be performed multiple times, continuously or intermittently.

As an example, the water supply unit 14 may perform the addition of a replenishment liquid L in the range of 0.5 to 1.7 L per kg of uncooked rice contained in a rice foodstuff R while the rice foodstuff R is passing through the first zone Z1. The water supply unit 14 may perform the addition of a replenishment liquid L preferably in the range of 0.55 to 1.5 L per kg of such uncooked rice, and even more preferably in the range of 0.6 to 1.3 L per kg of such uncooked rice. The amount of replenishment liquid L added from the water supply unit 14 may be appropriately adjusted according to the rice variety and/or a desired texture and the moisture value of the rice.

The water supply unit 14 shown in FIG. 1 includes a plurality of water supply devices 14a, and the plurality of water supply devices 14a are installed, on the chamber unit 20, at a higher position than the conveyance belt of the conveyance unit 11. Each water supply device 14a has one or more liquid discharge ports that discharge a replenishment liquid L inside the chamber unit 20.

The specific arrangement of the plurality of water supply devices 14a and the specific manner in which a replenishment liquid L is discharged from each water supply device 14a are not limited. Each water supply device 14a may, for example, eject a replenishment liquid L in only one direction or may eject a replenishment liquid L in multiple directions.

However, at least two of the plurality of water supply devices 14a are provided in the first zone Z1, spaced apart from each other from upstream towards downstream of the conveyance of a rice foodstuff R. In other words, the water supply devices 14a are installed in a plurality of locations (e.g., about 6 to 10 locations), respectively, in the first zone Z1 that are separated from each other with respect to the conveyance direction Dc of a rice foodstuff R.

The plurality of water supply devices 14a installed at multiple locations in this manner may, for example, supply a replenishment liquid L to a rice foodstuff R in the first zone Z1 without interruption in terms of the conveyance direction Dc of the rice foodstuff R. Alternatively, the plurality of water supply devices 14a may supply a replenishment liquid L to a rice foodstuff R in the first zone Z1 intermittently in terms of the conveyance direction Dc of the rice foodstuff R. Specifically, in the first zone Z1, there may be an area where a rice foodstuff R on the conveyance belt directly receives a replenishment liquid L from a water supply device 14a and an area where a rice foodstuff R on the conveyance belt does not directly receive a replenishment liquid L from a water supply device 14a.

With respect to the width direction of the conveyance belt (the direction perpendicular to the paper surface of FIG. 1), two or more water supply devices 14a may be provided away from each other, or only a single water supply device 14a may be provided. The “width direction of the conveyance belt” here is a horizontal direction that is perpendicular to the conveyance direction Dc of a rice foodstuff R by the conveyance belt (i.e., the running direction of the upper belt part). The replenishment liquid L may be supplied from one or more water supply devices 14a to a rice foodstuff R on the conveyance belt simultaneously in terms of the entirety in the width direction in such a manner that the replenishment liquid L is uniformly supplied to the entire rice foodstuff R.

In the example shown in FIG. 1, the temperature of a replenishment liquid L supplied to a rice foodstuff R by the water supply device 14a located closest to the second zone Z2 among the plurality of water supply devices 14a is lower than the temperature of a replenishment liquid L supplied to a rice foodstuff R by the other water supply devices 14a. By relatively lowering the temperature of a replenishment liquid L supplied at the position closest to the second zone Z2 in this manner, the surface viscosity of a rice foodstuff R after cooking (in particular, the cooked rice) may be effectively suppressed.

As an example, the temperature of a replenishment liquid L given to a rice foodstuff R from the water supply devices 14a other than the water supply device 14a provided at the position closest to the second zone Z2 may be adjusted to 60° C. or higher and 90° C. or lower (e.g., 60° C. or higher and 70° C. or lower). In this case, the inventors confirmed that the surface viscosity of a rice foodstuff R after cooking was significantly suppressed by setting the temperature of a replenishment liquid L given to the rice foodstuff R from the water supply device 14a provided at the position closest to the second zone Z2 to 40° C. or lower (e.g., 20° C. to 30° C.).

The steamed rice production apparatus 10 shown in FIG. 1 comprises a plurality of storage units 32 (i.e., a first storage unit 32a and a second storage unit 32b) that store a replenishment liquid L. At least one of the plurality of water supply devices 14a ejects a replenishment liquid L sent from the first storage unit 32a, and the other water supply devices 14a eject a replenishment liquid L sent from the storage unit (the second storage unit 32b) other than the first storage unit 32a.

In the example shown in FIG. 1, the first storage unit 32a and the second storage unit 32b store a replenishment liquid L of different temperatures. Specifically, the first storage unit 32a stores a replenishment liquid L at a relatively low temperature, and the second storage unit 32b stores the replenishment liquid L at a relatively high temperature.

Of the plurality of water supply devices 14a, the water supply device 14a located closest to the second zone Z2 ejects a low temperature replenishment liquid L sent from the first storage unit 32a. At least one of the other water supply devices 14a (in the example shown in FIG. 1, all of the other water supply devices 14a) eject a high temperature replenishment liquid L sent from the second storage unit 32b.

According to the above-mentioned steamed rice production apparatus 10, a rice foodstuff R conveyed by the conveyance unit 11 is, in first zone Z1, steamed by steam while receiving a supply of a replenishment liquid L, and after that is, in the second zone Z2, steamed by steam without receiving a supply of a replenishment liquid L, thereby performing rice cooking.

The time for steaming a rice foodstuff R by steam in the first zone Z1 (a first rice steaming process time) and the time for steaming a rice foodstuff R by steam in the second zone Z2 (a second rice steaming process time) are adjusted according to the actual conditions of the rice foodstuff R.

The inventors conducted rice cooking multiple times using the above-mentioned steamed rice production apparatus 10 while changing the first rice steaming process time and the second rice steaming process time, and evaluated the quality of the rice cooking method in each rice cooking. As a result, the inventors gained insights that adjusting the first rice steaming process time and the second rice steaming process time as follows is advantageous for stably providing high quality cooked rice.

Specifically, it is preferable that the second rice steaming process time should be equal to or greater than 3/10 of the total time of the first rice steaming process time and the second rice steaming process time. It is also preferable that the second rice steaming process time should be equal to or less than ½ of the total time of the first rice steaming process time and the second rice steaming process time.

The total time of the first rice steaming process time and the second rice steaming process time may vary depending on the rice content in a rice foodstuff R and other ingredients contained in a rice foodstuff R, and is approximately 15 to 25 minutes, for instance.

The inventors of the present case conducted various types of rice cooking (Example 1 and Example 2) and evaluated the quality of the rice cooking from various perspectives.

Specifically, in Example 1, rice cooking was performed using the above-mentioned steamed rice production apparatus 10, and the supply of a replenishment liquid L to a rice foodstuff R was performed only in the first zone Z1 of the rice steaming zone Z0. In Example 2, in the above-mentioned steamed rice production apparatus 10, a water supply unit 14 (a plurality of water supply devices 14a) was also installed in the second zone Z2, and the supply of a replenishment liquid L to a rice foodstuff R was performed in the entire rice steaming zone Z0 (both the first zone Z1 and the second zone Z2).

The other rice cooking conditions were adjusted to similar conditions between Examples 1 and 2 as much as possible, and Examples 1 and 2 were conducted using a rice foodstuff R containing only rice.

The evaluation results (i.e., the evaluator's sensory evaluation results) of the cooked rice obtained in each of Examples 1 and 2 are shown in Table 1 below.

TABLE 1

| | Example 1 | Example 2 |
|---|---|---|
| | Steamed Rice Cooking | Steamed Rice Cooking |
| | (Water Supply in First | (Water Supply in First |
| | Zone Only) | Zone and Second Zone) |
| Fluffiness | Good | Average |
| Graininess | Good | Good |
| Less Stickiness | Good | Good |

In Table 1 above, “Good” indicates a better result than “Average”.

For example, in terms of “fluffiness” of the cooked rice, the cooked rice obtained in Example 1 was superior to the cooked rice obtained in Example 2.

Further, in terms of the “Graininess” and “Less Stickiness” of the cooked rice, the cooked rice obtained in Example 1 was excellent and comparable to the cooked rice obtained in Example 2.

As shown in Table 1 above, the above-mentioned steamed rice production apparatus 10 and steamed rice production method shown in FIG. 1 (Example 1) shows an overall good rice cooking evaluation and is advantageous for obtaining high-quality cooked rice.

As explained above, according to the present embodiment, steaming rice is performed by supplying the necessary and sufficient amount of water (a replenishment liquid L) in the first zone Z1, which is located upstream of the rice steaming zone Z0, while not supplying water as a liquid in the second zone Z2, which is located downstream of the rice steaming zone Z0.

This makes it possible to provide cooked rice of excellent quality.

Further, according to the present embodiment, the configuration of the steamed rice production apparatus 10 can be simplified because the first zone Z1 and the second zone Z2 are provided horizontally next to each other. For example, a conveyance unit 11 that is common between the first zone Z1 and the second zone Z2 can be used, and a single conveyance unit 11 can convey rice foodstuff R in the first zone Z1 and the second zone Z2.

### Second Embodiment

In the present embodiment, elements identical or corresponding to those in the first embodiment described above are marked with the same reference numerals, and their detailed descriptions are omitted.

Although the first zone Z1 and the second zone Z2 are staggered from each other in the horizontal direction in the first embodiment described above, the first zone Z1 and the second zone Z2 may be staggered from each other in the height direction.

Although not shown in the drawing, a steamed rice production apparatus 10 of the second embodiment comprises a plurality of rice steaming units staggered in the height direction. For example, a three-tiered rice steaming unit (a first rice steaming unit, a second rice steaming unit, and a third rice steaming unit) may be provided.

In a case where a three-tiered rice steaming unit is provided, the first rice steaming unit, the second rice steaming unit and the third rice steaming unit are, for example, positioned in this order from higher to lower positions. In other words, the third rice steaming unit is positioned lower than the first rice steaming unit, and the second rice steaming unit is positioned between the first and third rice steaming units in the height direction.

The water supply unit 14 of the present embodiment also includes a plurality of water supply devices 14a.

One or more water supply devices 14a may be provided in the first rice steaming unit, the first rice steaming unit may include the first zone Z1 but may not include the second zone Z2, and the entire first rice steaming unit may be provided as the first zone Z1.

One or more water supply devices 14a may be provided in the second rice steaming unit, and the second rice steaming unit may include both the first zone Z1 and the second zone Z2. In such a case, the upstream side of the second rice steaming unit is provided as the first zone Z1 where a replenishment liquid L from the water supply device(s) 14a is supplied to a rice foodstuff R that is conveyed by the conveyance unit 11. On the other hand, the downstream side of the second rice steaming unit is provided as the second zone 72 where a replenishment liquid L is not supplied to a rice foodstuff R.

A water supply device 14a (i.e., a water supply unit 14) may not be provided in the third rice steaming unit, and the third rice steaming unit may not include the first zone Z1 but may include the second zone Z2. In other words, the entire third rice steaming unit may be provided as the second zone Z2.

The first rice steaming unit, the second rice steaming unit and the third rice steaming unit basically have a common configuration except for the configuration related to the water supply unit 14 (the water supply devices 14a). Specifically, each of the first to third rice steaming units has a conveyance unit 11, a steam supply unit 12, and stirring devices 13 similar to the steaming rice production apparatus 10 of the first embodiment described above.

However, the conveyance direction of a rice foodstuff R in the first rice steaming unit and the conveyance direction of a rice foodstuff R in the second rice steaming unit may be opposite to each other. Further, the conveyance direction of a rice foodstuff R in the second rice steaming unit and the conveyance direction of a rice foodstuff R in the third rice steaming unit may be opposite to each other.

The other configurations of the steamed rice production apparatus 10 of the present embodiment may be similar to the steamed rice production apparatus 10 of the first embodiment described above.

According to the steamed rice production apparatus 10 and the steamed rice production method of the present embodiment, a portion of the conveyance unit 11 of the second rice steaming unit may extend directly below the conveyance unit 11 of the first rice steaming unit. Also, a portion of the conveyance unit 11 of the third rice steaming unit may extend directly below the conveyance unit 11 of the second rice steaming unit.

In this case, it is possible to secure the rice steaming zone Z0 (i.e., the first zone Z1 and the second zone Z2) of sufficient length while suppressing the increase in the horizontal direction in the installation space for the steamed rice production apparatus 10 as a whole.

In the steamed rice production apparatus 10 and the steamed rice production method of the present embodiment, a plurality of water supply devices 14a may be provided to correspond to the entire second rice steaming unit.

Specifically, a plurality of water supply devices 14a may be provided in the second rice steaming unit in such a manner that a replenishment liquid L can be discharged toward the entire conveyance unit 11 of the second rice steaming unit. In this case, it is preferable that two or more water supply devices 14a in the second rice steaming unit should be provided away from each other from upstream towards downstream in the conveyance direction. It is also preferable that under the control of a control unit (not shown in the drawing) or manually, whether or not a replenishment liquid L is discharged from each water supply device 14a provided in the second rice steaming unit can be switched.

By providing a plurality of water supply devices 14a, which is capable of switching whether or not to discharge a replenishment liquid L, in the second rice steaming unit to be arranged in the conveyance direction in this manner, it is possible to adaptively adjust the range of the first zone Z1 and the second zone Z2 in the second rice steaming unit.

Specifically, the ranges of the first zone Z1 and the second zone Z2 in the second rice steaming unit can be changed adaptively by changing a water supply device(s) 14a that actually discharges a replenishment liquid L and a water supply device(s) 14a that does not actually discharge a replenishment liquid L in the second rice steaming unit. Therefore, the time during which a rice foodstuff R is steamed by steam in the first zone Z1 (the first rice steaming process time) and the time during which a rice foodstuff R is steamed by steam in the second zone Z2 (the second rice steaming process time) can be optimally adjusted according to actual rice cooking conditions (e.g., the conditions of a rice foodstuff R, etc.).

The optimum ratio of the first rice steaming process time and the second rice steaming process time may vary depending on various factors such as the components of a rice foodstuff R, season, time of day, and temperature and humidity of the surrounding environment. By adjusting the ratio of the first zone Z1 and the second zone Z2 of the second rice steaming unit according to these factors, it is possible to optimize the ratio of the first rice steaming process time and the second rice steaming process time in the steaming rice production apparatus 10 as a whole.

The fact that the ratio of the first zone Z1 and the second zone Z2 is variable as described above allows one steamed rice production apparatus 10 to flexibly respond to various rice cooking conditions.

The conveyance speed of a rice foodstuff R by the conveyance unit 11 may or may not be the same between the first zone Z1 and the second zone Z2. For example, by changing the conveyance speed of a rice foodstuff R by the conveyance unit 11 in the first zone Z1, the first rice steaming process time (i.e., the rice steaming time in the first zone Z1) in the entire steaming process can be flexibly adjusted. Also, by changing the conveyance speed of a rice foodstuff R by the conveyance unit 11 in the second zone Z2, the second rice steaming process time (i.e., the rice steaming time in the second zone Z2) in the entire steaming process can be flexibly adjusted.

### [Variant Examples]

Although the plurality of storage units 32 (the first storage unit 32a and the second storage unit 32b) store a replenishment liquid L of different temperatures respectively in the above-described embodiments, a plurality of types of replenishment liquids L with different characteristics other than temperature may be stored in the plurality of storage units 32 (the first storage unit 32a and the second storage unit 32b) respectively. For example, multiple types of replenishment liquids L containing different components may be stored in the respective storage units 32.

Further, in the embodiments described above, each water supply unit 14 is assigned one storage unit 32 (the first storage unit 32a or the second storage unit 32b), but each water supply unit 14 may be assigned two or more storage units 32. For example, a replenishment liquid L from the first storage unit 32a and a replenishment liquid L from the second storage unit 32b may be blended in the midway, and the blended replenishment liquid L may be supplied to each water supply device 14a.

The present disclosure is not limited to the embodiments and variant examples described above. Various variations may be added to each element of the above-described embodiments and variant examples. Further, the configurations of the above-described embodiments and variant examples may be combined in whole or in part.

The technical categories in which the above technical ideas are embodied are not limited. For example, the above-described technical idea may be embodied by a computer program that causes a computer to execute one or more procedures (steps) included in the above-described methods. Further, the above-described technical ideas may be embodied by a computer-readable non-transitory recording medium in which such a computer program is recorded.

### [Additional Statement]

As is clear from the above, the present disclosure includes the following aspects.

### [Aspect 1]

A steamed rice production method including:
a first rice steaming step of, in a first zone in a steamed rice production apparatus, supplying a replenishment liquid containing water to a rice foodstuff containing rice and steaming the rice foodstuff by steam; and
a second rice steaming step of, in a second zone in the steamed rice production apparatus, steaming the rice foodstuff by steam after the first rice steaming step without supplying water to the rice foodstuff.

### [Aspect 2]

The steamed rice production method as defined in aspect 1, wherein the replenishment liquid is supplied to the rice foodstuff in the first zone by water sprinkling.

### [Aspect 3]

The steamed rice production method as defined in aspect 1 or 2, wherein a time during which the rice foodstuff is steamed by steam in the second zone is equal to or greater than 3/10 of a total time during which the rice foodstuff is steamed by steam in the first zone and the second zone.

### [Aspect 4]

The steamed rice production method as defined in any one of aspects 1 to 3, wherein a time during which the rice foodstuff is steamed by steam in the second zone is equal to or less than ½ of a total time during which the rice foodstuff is steamed by steam in the first zone and the second zone.

### [Aspect 5]

The steamed rice production method as defined in any one of aspects 1 to 4, wherein the rice foodstuff is conveyed from the first zone to second zone without interruption.

### [Aspect 6]

A steamed rice production apparatus comprising:
a conveyance unit that conveys a rice foodstuff containing rice throughout a rice steaming zone that includes a first zone and a second zone located downstream from the first zone;
a steam supply unit that supplies steam to the first zone and the second zone; and
a water supply unit that supplies a replenishment liquid containing water to the rice foodstuff conveyed by the conveyance unit in the first zone,
wherein in the second zone, the rice foodstuff conveyed by the conveyance unit is steamed by the steam but does not receive supply of water.

### [Aspect 7]

The steamed rice production apparatus as defined in aspect 6, wherein:
the water supply unit includes a plurality of water supply devices,
at least two of the plurality of water supply devices are provided in the first zone to be spaced apart from each other from an upstream side towards a downstream side of conveyance of the rice foodstuff, and
temperature of the replenishment liquid supplied to the rice foodstuff by a water supply device located closest to the second zone among the plurality of water supply devices is lower than temperature of the replenishment liquid supplied to the rice foodstuff by another water supply device.

### [Aspect 8]

The steamed rice production apparatus as defined in aspect 6 or 7, comprising a plurality of storage units that store the replenishment liquid and include a first storage unit,
wherein the water supply unit includes a plurality of water supply devices, and
wherein at least one of the plurality of water supply devices ejects the replenishment liquid sent from the first storage unit, and another water supply device ejects the replenishment liquid sent from a storage unit other than the first storage unit.

### REFERENCE SIGNS LIST

10 Steamed rice production apparatus
11 Conveyance unit
12 Steam supply unit
12a Steam generation unit
12b Steam jet line
13 Stirring device
14 Water supply unit
14a Water supply device
20 Chamber unit
31 Rice supply unit
32 Storage unit
32a First storage unit
32b Second storage unit
Dc Conveyance direction
L Replenishment liquid
R Rice foodstuff
Z0 Rice steaming zone
Z1 First zone
Z2 Second zone

1. A steamed rice production method including:
a first rice steaming step of, in a first zone in a steamed rice production apparatus, supplying a replenishment liquid containing water to a rice foodstuff containing rice and steaming the rice foodstuff by steam; and
a second rice steaming step of, in a second zone in the steamed rice production apparatus, steaming the rice foodstuff by steam after the first rice steaming step without supplying water to the rice foodstuff.

2. The steamed rice production method as defined in claim 1, wherein the replenishment liquid is supplied to the rice foodstuff in the first zone by water sprinkling.

3. The steamed rice production method as defined in claim 1, wherein a time during which the rice foodstuff is steamed by steam in the second zone is equal to or greater than 3/10 of a total time during which the rice foodstuff is steamed by steam in the first zone and the second zone.

4. The steamed rice production method as defined in claim 1, wherein a time during which the rice foodstuff is steamed by steam in the second zone is equal to or less than ½ of a total time during which the rice foodstuff is steamed by steam in the first zone and the second zone.

5. The steamed rice production method as defined in claim 1, wherein the rice foodstuff is conveyed from the first zone to second zone without interruption.

6. A steamed rice production apparatus comprising:
a conveyance unit that conveys a rice foodstuff containing rice throughout a rice steaming zone that includes a first zone and a second zone located downstream from the first zone;
a steam supply unit that supplies steam to the first zone and the second zone; and
a water supply unit that supplies a replenishment liquid containing water to the rice foodstuff conveyed by the conveyance unit in the first zone,
wherein in the second zone, the rice foodstuff conveyed by the conveyance unit is steamed by the steam but does not receive supply of water.

7. The steamed rice production apparatus as defined in claim 6, wherein:
the water supply unit includes a plurality of water supply devices,
at least two of the plurality of water supply devices are provided in the first zone to be spaced apart from each other from an upstream side towards a downstream side of conveyance of the rice foodstuff, and
temperature of the replenishment liquid supplied to the rice foodstuff by a water supply device located closest to the second zone among the plurality of water supply devices is lower than temperature of the replenishment liquid supplied to the rice foodstuff by another water supply device.

8. The steamed rice production apparatus as defined in claim 6, comprising a plurality of storage units that store the replenishment liquid and include a first storage unit,
wherein the water supply unit includes a plurality of water supply devices, and
wherein at least one of the plurality of water supply devices ejects the replenishment liquid sent from the first storage unit, and another water supply device ejects the replenishment liquid sent from a storage unit other than the first storage unit.
